(19) United States
(12) Patent Application Publication
(10) Pub. No.: US 2019/0112419 A1
(43) Pub. Date: Apr. 18, 2019

(54) BLEND AND METHOD FOR MANUFACTURING THE SAME

(71) Applicant: INDUSTRIAL TECHNOLOGY RESEARCH INSTITUTE, Hsinchu (TW)

(72) Inventors: Shu-Chen LI, Yuanli Township (TW); Cheng-Jyun HUANG, Taoyuan City (TW); Hung-Jen LIU, Hsinchu City (TW); Guang-Way JANG, Hsinchu City (TW)

(73) Assignee: INDUSTRIAL TECHNOLOGY RESEARCH INSTITUTE, Hsinchu (TW)

(21) Appl. No.: 16/163,095

(22) Filed: Oct. 17, 2018

Related U.S. Application Data
(60) Provisional application No. 62/573,259, filed on Oct. 17, 2017.

(51) Int. Cl. C08G 63/183; C08G 63/40; C08G 63/66; C08L 67/02; C08J 3/00

(52) U.S. Cl. CPC C08G 63/183; C08G 63/40; C08J 3/005; C08L 67/025; C08G 63/66

(57) ABSTRACT

A blend is provided, which includes 50 to 99 parts by weight of PET and 1 to 50 parts by weight of modified PEF. The modified PEF is polymerized of diacid, ester of diacid, or a combination thereof and polyol. The diacid, ester of diacid, or a combination thereof includes (1) furan dicarboxylic acid, dialkyl furandicarboxylate, or a combination thereof or (2) furan dicarboxylic acid, dialkyl furandicarboxylate, or a combination thereof and spiro-diacid. The polyol includes (3) C₂-C₁₄ polyol or (4) C₂-C₁₄ polyol and spiro-diol. The diacid, ester of diacid, or a combination thereof includes (1) furan dicarboxylic acid, dialkyl furandicarboxylate, or a combination thereof, the polyol includes 1 to 3 parts by mole of (4) C₂-C₁₄ polyol and spiro-diol, wherein the spiro-diol and the furan dicarboxylic acid, dialkyl furandicarboxylate, or a combination thereof have a weight ratio of 500 ppm to 4000 ppm.

### CROSS REFERENCE TO RELATED APPLICATIONS

This application claims the benefit of U.S. Provisional Application No. 62/573,259 filed on Oct. 17, 2017. The entirety of which is incorporated by reference herein.

### TECHNICAL FIELD

The technical field relates to a blend and a polymer ratio of the blend.

### BACKGROUND

Polyethylene terephthalate (PET) material has advantages such as low cost, light-weight, and mature recycling technology, and thereby it is widely applied in fibers, optical films, polyester packaging bottles, and the like. However, PET also has disadvantages such as insufficient gas barrier ability in the application of packaging material. A PET blend with a high gas barrier ability needs to be developed for packaging beer, soft drinks, and the like due to the high market potential. Beer bottles made of PET have a market share of 40%, which was quickly developed in Europe and America but is just starting in China with a large market potential. The conventional PET bottles with a high gas barrier ability are classified as single layered blend of PET, multi-layered extrusion, or inorganic coating. A single-layered, high gas barrier, and recyclable PET packaging material has not existed until now.

### SUMMARY

One embodiment of the disclosure provides a blend, including: 50 to 99 parts by weight of polyethylene terephthalate (PET); and 1 to 50 parts by weight of modified polyethylene furanoate (PEF), and PET and the modified PEF have a total weight of 100 parts by weight, wherein the modified PEF is polymerized of diacid, ester of diacid, or a combination thereof and polyol; the diacid, ester of diacid, or a combination thereof includes (1) furan dicarboxylic acid, dialkyl furandicarboxylate, or a combination thereof or (2) furan dicarboxylic acid, dialkyl furandicarboxylate, or a combination thereof and spiro-diacid; and the polyol includes (3) C₂-C₁₄ polyol or (4) C₂-C₁₄ polyol and spiro-diol;

wherein the spiro-diol has a Formula (I):

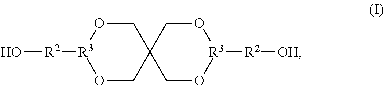

and the spiro-diacid has a Formula (II):

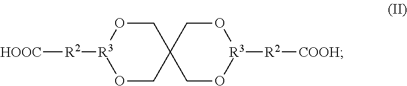

wherein each R² is independently single bond,

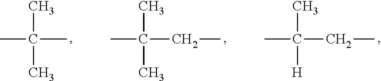

or
C₁-C₄ linear alkylene; and each R³ is independently

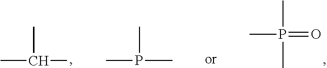

and when (a) diacid, ester of diacid, or a combination thereof includes 1 part by mole of (1) furan dicarboxylic acid, dialkyl furandicarboxylate, or a combination thereof, the polyol includes 1 to 3 parts by mole of (4) C₂-C₁₄ polyol and spiro-diol, and the spiro-diol and the furan dicarboxylic acid, dialkyl furandicarboxylate, or a combination thereof have a weight ratio of 500 ppm to 4000 ppm; or when (b) diacid, ester of diacid, or a combination thereof includes 1 part by mole of (2) furan dicarboxylic acid, dialkyl furandicarboxylate, or a combination thereof and spiro-diacid, the polyol includes 1 to 3 parts by mole of (3) C₂-C₁₄ polyol or (4) C₂-C₁₄ polyol and spiro-diol, wherein the spiro-diacid and the furan dicarboxylic acid, dialkyl furandicarboxylate, or a combination thereof have a weight ratio of 500 ppm to 4000 ppm, or a total weight of the spiro-diacid and the spiro-diol and the weight of the furan dicarboxylic acid, dialkyl furandicarboxylate, or a combination thereof have a ratio of 500 ppm to 4000 ppm.

In one embodiment, the modified PEF has a number average molecular weight of 30,000 to 100,000.

In one embodiment, PET has a number average weight molecular weight of 10,000 to 100,000.

In one embodiment, the furan dicarboxylic acid includes 2,5-furan dicarboxylic acid, 3,4-furan dicarboxylic acid, 2,3-furan dicarboxylic acid, or a combination thereof.

In one embodiment, the dialkyl furandicarboxylate includes dimethyl furan-2,5-dicarboxylate, dimethyl furan-3,4-dicarboxylate, dimethyl furan-2,3-dicarboxylate, or a combination thereof.

In one embodiment, the C₂-C₁₄ polyol includes ethylene glycol, 1,3-propylene glycol, glycerol, 1,4-butylene glycol, 1,5-pentylene glycol, neo-pentylene glycol, 1,6-hexylene glycol, 1,7-heptylene glycol, 1,8-octylene glycol, 1,9-nonylene glycol, decylene glycol, undecylene glycol, dodecylene glycol, tetradecylene glycol, rosin-diol, isosorbide, 2,5-furandiol, or a combination thereof.

One embodiment of the disclosure provides a method of manufacturing a blend, including: mixing diacid, ester of diacid, or a combination thereof with polyol to perform an esterification and a condensation polymerization for forming a prepolymer; and performing a solid-state polymerization of the prepolymer to form a modified polyethylene furanoate (PEF); and blending 50 to 99 parts by weight of polyethylene terephthalate (PET) and 1 to 50 parts by weight of the modified PEF to form a blend, and PET and the modified-PEF have a total weight of 100 parts by weight, wherein the diacid, ester of diacid, or a combination thereof includes (1) furan dicarboxylic acid, dialkyl furandicarboxylate, or a combination thereof or (2) furan dicarboxylic acid, dialkyl furandicarboxylate, or a combination thereof and spiro-diacid; and the polyol includes (3) C₂-C₁₄ polyol or (4) C₂-C₁₄ polyol and spiro-diol; wherein the spiro-diol has a Formula (I):

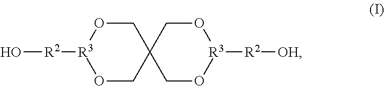

and the spiro-diacid has a Formula (II):

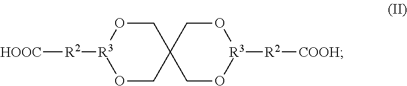

wherein each R² is independently single bond,

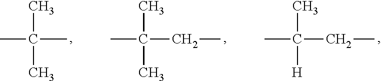

or C₁-C₄ linear alkylene;
and each R³ is independently

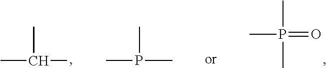

and when (a) diacid, ester of diacid, or a combination thereof includes 1 part by mole of (1) furan dicarboxylic acid, dialkyl furandicarboxylate, or a combination thereof, the polyol includes 1 to 3 parts by mole of (4) C₂-C₁₄ polyol and spiro-diol, and the spiro-diol and the furan dicarboxylic acid, dialkyl furandicarboxylate, or a combination thereof have a weight ratio of 500 ppm to 4000 ppm; or when (b) diacid, ester of diacid, or a combination thereof includes 1 part by mole of (2) furan dicarboxylic acid, dialkyl furandicarboxylate, or a combination thereof and spiro-diacid, the polyol includes 1 to 3 parts by mole of (3) C₂-C₁₄ polyol or (4) C₂-C₁₄ polyol and spiro-diol, wherein the spiro-diacid and the furan dicarboxylic acid, dialkyl furandicarboxylate, or a combination thereof have a weight ratio of 500 ppm to 4000 ppm, or a total weight of the spiro-diacid and the spiro-diol and the weight of the furan dicarboxylic acid, dialkyl furandicarboxylate, or a combination thereof have a ratio of 500 ppm to 4000 ppm.

In one embodiment, the step of blending PET and the modified PEF to form the blend is performed at a temperature of 265° C. to 300° C. for a period of 30 seconds to 500 seconds.

In one embodiment, the modified PEF has a number average molecular weight of 30,000 to 100,000.

In one embodiment, PET has a number average weight molecular weight of 10,000 to 100,000.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a method of manufacturing a blend. Diacid, ester of diacid, or a combination thereof is mixed with polyol to perform an esterification and a condensation polymerization for forming a prepolymer. Subsequently, the prepolymer is solid-state polymerized to form a modified polyethylene furanoate (PEF). For details of the method of forming the modified PEF, refer to previous U.S. Patent Publication No. US20170121453A1 and US20170121859A1 from the Applicant, which is incorporated into this application. For example, the modified PEF is polymerized of the diacid, the ester of the diacid, or a combination thereof with the polyol. The diacid, ester of diacid, or a combination thereof includes (1) furan dicarboxylic acid, dialkyl furandicarboxylate, or a combination thereof or (2) furan dicarboxylic acid, dialkyl furandicarboxylate, or a combination thereof and spiro-diacid. The polyol includes (3) C₂-C₁₄ polyol or (4) C₂-C₁₄ polyol and spiro-diol. The spiro-diol has a Formula (I):

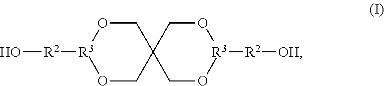

and the spiro-diacid has a Formula (II):

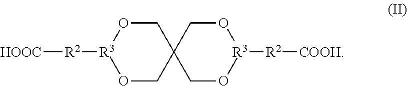

Each R² is independently single bond,

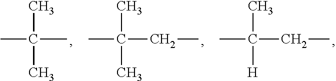

or C₁-C₄ linear alkylene;
and each R³ is independently

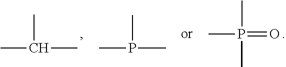

When (a) diacid, ester of diacid, or a combination thereof includes 1 part by mole of (1) furan dicarboxylic acid, dialkyl furandicarboxylate, or a combination thereof, the polyol includes 1 to 3 parts by mole of (4) C₂-C₁₄ polyol and spiro-diol, wherein the spiro-diol and the furan dicarboxylic acid, dialkyl furandicarboxylate, or a combination thereof have a weight ratio of 500 ppm to 4000 ppm. In one embodiment, the spiro-diol and the furan dicarboxylic acid, dialkyl furandicarboxylate, or a combination thereof have a weight ratio of 1500 ppm to 3000 ppm. A ratio of spiro-diol that is too low cannot obviously enhance the gas barrier effect of the blend. If the spiro-diol ratio is too high, the modified PEF cannot be easily dispersed in the blend.

When (b) diacid, ester of diacid, or a combination thereof includes 1 part by mole of (2) furan dicarboxylic acid, dialkyl furandicarboxylate, or a combination thereof and spiro-diacid, the polyol includes 1 to 3 parts by mole of (3) C₂-C₁₄ polyol, wherein the spiro-diacid and the furan dicarboxylic acid, dialkyl furandicarboxylate, or a combination thereof have a weight ratio of 500 ppm to 4000 ppm. In one embodiment, the spiro-diacid and the furan dicarboxylic acid, dialkyl furandicarboxylate, or a combination thereof have a weight ratio of 1500 ppm to 3000 ppm. A ratio of spiro-diacid that is too low cannot obviously enhance the gas barrier effect of the blend. If the spiro-acid ratio is too high, the modified PEF cannot be easily dispersed in the blend.

Alternatively, when (b) diacid, ester of diacid, or a combination thereof includes 1 part by mole of (2) furan dicarboxylic acid, dialkyl furandicarboxylate, or a combination thereof and spiro-diacid, the polyol includes 1 to 3 parts by mole of (4) C₂-C₁₄ polyol and spiro-diol, wherein a total weight of the spiro-diacid and the spiro-diol and the weight of the furan dicarboxylic acid, dialkyl furandicarboxylate, or a combination thereof have a ratio of 500 ppm to 4000 ppm. In one embodiment, a total weight of the spiro-diacid and the spiro-diol and the weight of the furan dicarboxylic acid, dialkyl furandicarboxylate, or a combination thereof have a ratio of 1500 ppm to 3000 ppm. If the total ratio of the spiro-diacid and the spiro-diol is too low then it cannot obviously enhance the gas barrier effect of the blend. If the total ratio of the spiro-acid and spiro-diol is too high, the modified PEF cannot be easily dispersed in the blend.

In some embodiments, the furan dicarboxylic acid includes 2,5-furan dicarboxylic acid, 3,4-furan dicarboxylic acid, 2,3-furan dicarboxylic acid, or a combination thereof. In some embodiments, the dialkyl furandicarboxylate includes dimethyl furan-2,5-dicarboxylate, dimethyl furan-3,4-dicarboxylate, dimethyl furan-2,3-dicarboxylate, or a combination thereof.

In one embodiment, the polyol may include C₂-C₈ polyol, such as C₂-C₆ linear diol. In one embodiment, the polyol may include ethylene glycol, 1,3-propylene glycol, glycerol, 1,4-butylene glycol, 1,5-pentylene glycol, neo-pentylene glycol, 1,6-hexylene glycol, 1,7-heptylene glycol, 1,8-octylene glycol, 1,9-nonylene glycol, decylene glycol, undecylene glycol, dodecylene glycol, tetradecylene glycol, rosin-diol, isosorbide, 2,5-furandiol, or a combination thereof.

In some embodiments, the modified PEF has a number average molecular weight (Mn) of 30,000 to 100,000. A modified PEF that is too low Mn cannot obviously enhance the gas barrier effect of the blend. A modified PEF with an Mn that is too high cannot be easily dispersed in the blend.

In one embodiment, the esterification includes transesterification and direct esterification. The esterification and the condensation polymerization can be catalyzed by an appropriate catalyst, and the catalyst content ranges from about 25 ppm to 500 ppm on the basis of the reactants. In one embodiment, the catalyst can be a metal catalyst that is tin-based, antimony-based, gallium-based, aluminum-based, titanium-based, germanium-based, lithium-based, magnesium-based, manganese-based, cobalt-based, or a combination thereof. For example, the catalyst can be titanium-based solid catalyst, titanium isopropoxide, titanium isobutoxide, or a combination thereof. The esterification and the condensation polymerization can be reacted at a temperature of about 170° C. to 260° C. for a period of about 1 hour to 8 hours, respectively.

After the esterification and the condensation polymerization, the prepolymer is obtained for further solid-state polymerization. The solid-state polymerization is performed at a temperature of about 170° C. to 210° C. for a period of about 4 hours to 120 hours (or about 16 hours to 56 hours). The solid-state polymerization easily causes thermal degradation yellowing (and melting adhesive lump) due to the temperature being too high or the period too long. The molecular weight of the branched polyester cannot be efficiently increased by a temperature that is too low or a period of solid-state polymerization that is too short.

In one embodiment, the prepolymer is further re-crystallized before the solid-state polymerization. The re-crystallization is performed at a temperature of about 110° C. to 170° C. (e.g. about 130° C. to 160° C.) for a period of about 0.5 hour to 2 hours. Subsequently, the solid obtained from re-crystallization is cracked to form powder for the solid-state polymerization.

In one embodiment, the spiro-diacid or the spiro-diol is ring-opened to branch the prepolymer for forming branched polyester in the solid-state polymerization. The branched polyester (e.g. the modified PEF) has a higher molecular weight. For example, when R² is

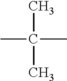

### and R³ is

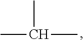

the solid-state polymerization is shown below, in which P′ is the other parts of the polyester.

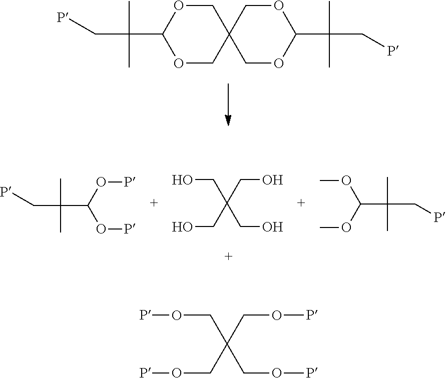

Note that the factors and mechanisms of polymerization are only illustrated and not intended to limit the embodiments of the disclosure. One skilled in the art may adopt any suitable factors and mechanisms to form the modified PEF, which are not limited to the above descriptions.

Subsequently, 50 to 90 parts by weight of PET and 1 to 50 parts by weight of the modified PEF are blended to form a blend, and PET and the modified PEF have a total weight of 100 parts by weight. The oxygen transmittance rate (OTR) of the blend cannot be efficiently reduced by a modified PEF ratio that is too low. The blend cost will be increased by a modified PEF ratio that is too high. In some embodiments, PET has a number average molecular weight (Mn) of 10,000 to 100,000.

In one embodiment, PET and the modified PEF can be blended at a temperature of 265° C. to 330° C. for a period of 30 seconds to 500 seconds. If the blending temperature is too low or the blending period is too short, the polymers cannot be easily dispersed and the gas barrier effect of the blend cannot be obviously enhanced. If the blending temperature is too high or the blending period is too long, the transesterification degree between PET and PEF will be too high, such that the gas barrier effect of the blend cannot be obviously enhanced. For example, PET and the modified PEF can be put into a micro-compounder under nitrogen to be blended. The blended sample can be directly extruded as a strip and then cut to pellets using a pelletizer. PET/PEF blend can be hot pressed to shape with a vacuum laminator. PET/PEF blend is pre-treated (e.g. heated under vacuum to be dried) to determine that its water content ratio was less than 500 ppm. Next, the temperature of the vacuum laminator is set to be higher than the melting point of PET/PEF blend. A mold frame is put onto a Teflon glass fiber cloth, and the blended sample is placed into the mold frame. The blended sample is covered by another Teflon glass fiber cloth, and the above tri-layered structure is interposed between two iron plates, and then put into the vacuum laminator of the stabilized temperature. In the vacuum laminator, the pressure is reduced, and PET/PEF blend is melted. The blended sample is also pressed by a force, and the vacuum was then broken. The iron plates are removed, and the sample is then cooled to shape. The sample is then taken from the mold frame to obtain PET/PEF blend sheet. The sheet is then pre-heated by a biaxial stretcher (KARO IV), and then simultaneously biaxially stretched along mechanical direction (MD) and transverse direction (TD), in which both the stretching ratios of MD and TD were 2.0 to 4.0 times. The sheet was pre-heated at a temperature of 90° C. to 110° C., such as 105° C. A sheet that is pre-heated by a temperature that is too high easily results in broken holes during stretching. A sheet that is pre-heated by a temperature that is too low easily results in broken film during stretching. In one embodiment, the biaxial stretching rate is 5%/second to 60%/second. If the biaxial stretching rate is too high, it may easily result in a broken film during stretching. A biaxial stretching rate that is too low will increase the time cost of the process.

Note that the factors and mechanisms of the blending and film formation are only illustrated and not intended to limit the embodiments of the disclosure. One skilled in the art may adopt suitable factors and mechanisms of the blending and film formation to form the blend and the film, which are not limited to the above descriptions.

The film of the blend has an oxygen transmittance rate (OTR) lower than that of a film of pure PET or a blend of PET and PEF (not modified). In other words, PEF modified by an appropriate amount of the spiro-diol, spiro-diacid, or a combination thereof can be blended with an appropriate amount of PET to form a blend with low OTR.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

The inherent viscosities of the polymers were measured by following step: the polyester sample was dissolved in dichloroacetic acid to form a solution with a concentration of 0.3 g/dL. The solution was placed into an Ubbelohde viscometer to measure the period of the solution flowing through two mark lines. The inherent viscosity of the polyester was calculated using the following formula:

$${η}_{inh} = \frac{ln ( \frac{t}{{t}_{0}} )}{c}$$

ηᵢₙₕ is the inherent viscosity. t is the period of the solution flowing through two mark lines. c is the solution concentration. The number average molecular weight of the polyester was measured by three-in-one detector GPC. The oxygen transmission rate (OTR) of the film (polymer or blend) was measured by Mocon OX-trans according to the standard ASTM D3985.

### Preparation Example 1 (PEF)

1 part by mole of dimethyl furan-2,5-dicarboxylate, 2.5 parts by mole of ethylene glycol, and 100 ppm of titanium-based solid catalyst (C-94, commercially available from World Chem Industries Co., Ltd, on the weight basis of the dimethyl furan-2,5-dicarboxylate) were put into a reaction tank. A condensing device and a methanol collecting cylinder were assembled with the reaction tank. The reaction tank was flushed and filled with nitrogen, and the mixture was heated to 190° C. in a salt bath, and stirred at 200 rpm by a rotator to perform a transesterification. After the catalyst was completely dissolved, methanol started to condense on the condenser. The transesterification was performed continuously for 3 hours, the condensed methanol was removed, and 0.1 wt % of an anti-oxidant (Irganox 1010, commercially available from BASF, on the weight basis of the dimethyl furan-2,5-dicarboxylate) was then added into the reaction tank. The pressure of the reaction tank was then gradually reduced to 50 torr in 30 minutes to remove the excess ethylene glycol. The salt bath temperature was gradually heated to 230° C., and the reaction pressure was gradually reduced to less than 1 torr to perform a condensation polymerization for 60 minutes. Finally, the vacuum of the condensation polymerization was broken by nitrogen, and the heating and the stirring were stopped. The cap on the reaction tank was then opened, and a viscous product was then obtained.

The viscous product was re-crystallized at 150° C. for 1 hour, then crushed by a crushing machine, and then separated by a sieve screen to collect powders with a size of less than 25 mesh for further solid-state polymerization. The powder was put into a reaction tank, and heated to 200° C. in a salt bath to perform the solid-state polymerization for 24 hours, in which the reaction pressure is less than 1 torr. Finally, polyethylene furanoate (PEF) was obtained, and its properties such as viscosity and number average molecular weight were analyzed and tabulated in Table 1.

### Preparation Example 2 (Modified PEF)

1 part by mole of dimethyl furan-2,5-dicarboxylate, 2.5 parts by mole of ethylene glycol, 2000 ppm of 3,9-bis(1,1-dimethyl-2-hydroxyethyl)-2,4,8,10-tetraoxaspiro[5.5]undecane (abbreviated as SPG monomer, on the weight basis of the dimethyl furan-2,5-dicarboxylate), and 100 ppm of C-94 (on the weight basis of the dimethyl furan-2,5-dicarboxylate) were put into a reaction tank. A condensing device and a methanol collecting cylinder were assembled with the reaction tank. The reaction tank was flushed and filled with nitrogen, and the mixture was heated to 190° C. in a salt bath, and stirred at 200 rpm by a rotator to perform a transesterification. After the catalyst was completely dissolved, methanol started to condense on the condenser. The transesterification was performed continuously for 3 hours, the condensed methanol was removed, and 0.1 wt % of an anti-oxidant (Irganox 1010, commercially available from BASF, on the weight basis of the dimethyl furan-2,5-dicarboxylate) was then added into the reaction tank. The pressure of the reaction tank was then gradually reduced to 50 torr in 30 minutes to remove the excess ethylene glycol. The salt bath temperature was gradually heated to 230° C., and the reaction pressure was gradually reduced to less than 1 torr to perform a condensation polymerization for 60 minutes. Finally, the vacuum of the condensation polymerization was broken by nitrogen, and the heating and the stirring were stopped. The cap on the reaction tank was then opened, and a viscous product was then obtained.

The viscous product was re-crystallized at 150° C. for 1 hour, then crushed by a crushing machine, and then separated by a sieve screen to collect powders with a size of less than 25 mesh for further solid-state polymerization. The powder was put into a reaction tank, and heated to 200° C. in a salt bath to perform the solid-state polymerization for 24 hours, in which the reaction pressure is less than 1 torr. Finally, modified PEF was obtained, and its properties such as viscosity and number average molecular weight were analyzed and tabulated in Table 1.

### Preparation Example 3

Preparation Example 3 was similar to Preparation Example 2, and the difference of Preparation Example 3 was the solid-state polymerization period was increased to 48 hours. The properties of the modified PEF are tabulated in Table 1.

### Preparation Example 4

Preparation Example 4 was similar to Preparation Example 2, and the difference of Preparation Example 4 was the SPG monomer amount. The properties of the modified PEF are tabulated in Table 1.

TABLE 1

| | Preparation | Preparation | Preparation | Preparation |
|---|---|---|---|---|
| | Example 1 | Example 2 | Example 3 | Example 4 |
| SPG monomer (ppm) | 0 | 2000 | 2000 | 3000 |
| Solid-state polymerization | 24 | 24 | 48 | 24 |
| period (hr) | | | | |
| Inherent viscosity (dL/g) | 0.733 | 0.985 | 1.096 | Gel |
| Number average molecular | 26,300 | 30,800 | 37,300 | Not measured |
| weight | | | | |
| Molecular structure | Linear | Branched | Branched | Crosslink |
| | structure | structure | structure | structure |

### Comparative Example 1

100 parts by weight of PET 5015w (commercially available from SHINKONG SYNTHETIC FIBERS CORP) was hot pressed to shape with a vacuum laminator. PET pellets were pre-treated at 140° C. under vacuum for 24 hours to determine that its water content ratio was less than 500 ppm. Next, the temperature of the vacuum laminator was set to 280° C. A mold frame was put onto a Teflon glass fiber cloth, and PET sample was placed into the mold frame. PET sample was covered by another Teflon glass fiber cloth, and the above tri-layered structure was interposed between two iron plates, and then put into the vacuum laminator of the stabilized temperature (e.g. 280° C.). In the vacuum laminator, the pressure was reduced to less than 10 torr, and PET sample was melted for about 5 to 10 minutes. The blended sample was also pressed by a force of 0 to 50 kgf/cm² for about 1 to 5 minutes, and the vacuum was then broken. The iron plates were removed, and the sample was then cooled to shape. The sample was then taken from the mold frame to obtain PET sheet. The thickness and OTR of PET sheet are shown in Table 2.

### Comparative Example 2-1

90 parts by weight of PET 5015w and 10 parts by weight of PEF in Preparation Example 1 were put into a micro-compounder (Xplore 15 ml, DSM) in a batch of about 10 g to 15 g under nitrogen, and then melt blended at 270° C. for 60 seconds at a screw rate of 100 rpm. The blended sample was directly extruded as a strip and then cut to pellets using a pelletizer. PET/PEF blend was hot pressed to shape with a vacuum laminator. PET/PEF blend was pre-treated at 140° C. under vacuum for 24 hours to determine that its water content ratio was less than 500 ppm. Next, the temperature of the vacuum laminator was set to be higher than the melting point of PET/PEF blend (e.g. 280° C.). A mold frame was put onto a Teflon glass fiber cloth, and the blended sample was placed into the mold frame. The blended sample was covered by another Teflon glass fiber cloth, and the above tri-layered structure was interposed between two iron plates, and then put into the vacuum laminator of the stabilized temperature (e.g. 280° C.). In the vacuum laminator, the pressure was reduced to less than 10 torr, and PET/PEF blend was melted for about 5 to 10 minutes. The blended sample was also pressed by a force of 0 to 50 kgf/cm² for about 1 to 5 minutes, and the vacuum was then broken. The iron plates were removed, and the sample was then cooled to shape. The sample was then taken from the mold frame to obtain PET/PEF blend sheet. The sheet was then pre-heated to 105° C. by the biaxial stretcher (KARO IV), and then simultaneously biaxially stretched along MD and TD at a stretching rate of 30%/second, in which both the stretching ratios of MD and TD were 3.0 times. The thickness and OTR of the stretched sheet are shown in Table 2.

### Comparative Example 2-2

90 parts by weight of PET 5015w and 10 parts by weight of PEF in Preparation Example 1 were put into a micro-compounder (Xplore 15 ml, DSM) in a batch of about 10 g to 15 g under nitrogen, and then melt blended at 270° C. for 60 seconds at a screw rate of 100 rpm. The blended sample was directly extruded as a strip and then cut to pellets using a pelletizer. PET/PEF blend was hot pressed to shape with a vacuum laminator. PET/PEF blend was pre-treated at 140° C. under vacuum for 24 hours to determine that its water content ratio was less than 500 ppm. Next, the temperature of the vacuum laminator was set to be higher than the melting point of PET/PEF blend (e.g. 280° C.). A mold frame was put onto a Teflon glass fiber cloth, and the blended sample was placed into the mold frame. The blended sample was covered by another Teflon glass fiber cloth, and the above tri-layered structure was interposed between two iron plates, and then put into the vacuum laminator of the stabilized temperature (e.g. 280° C.). In the vacuum laminator, the pressure was reduced to less than 10 torr, and PET/PEF blend was melted for about 5 to 10 minutes. The blended sample was also pressed by a force of 0 to 50 kgf/cm² for about 1 to 5 minutes, and the vacuum was then broken. The iron plates were removed, and the sample was then cooled to shape. The sample was then taken from the mold frame to obtain PET/PEF blend sheet. The sheet was then pre-heated to 105° C. by the biaxial stretcher (KARO IV), and then simultaneously biaxially stretched along MD and TD at a stretching rate of 30%/second, in which both the stretching ratios of MD and TD were 4.0 times. The thickness and OTR of the stretched sheet are shown in Table 2.

### Example 1-1

90 parts by weight of PET 5015w and 10 parts by weight of the modified PEF in Preparation Example 2 were put into a micro-compounder (Xplore 15 ml, DSM) in a batch of about 10 g to 15 g under nitrogen, and then melt blended at 270° C. for 60 seconds at a screw rate of 100 rpm. The blended sample was directly extruded as a strip and then cut to pellets using a pelletizer. PET/PEF blend was hot pressed to shape with a vacuum laminator. PET/PEF blend was pre-treated at 140° C. under vacuum for 24 hours to determine that its water content ratio was less than 500 ppm. Next, the temperature of the vacuum laminator was set to be higher than the melting point of PET/PEF blend (e.g. 280° C.). A mold frame was put onto a Teflon glass fiber cloth, and the blended sample was placed into the mold frame. The blended sample was covered by another Teflon glass fiber cloth, and the above tri-layered structure was interposed between two iron plates, and then put into the vacuum laminator of the stabilized temperature (e.g. 280° C.). In the vacuum laminator, the pressure was reduced to less than 10 torr, and PET/PEF blend was melted for about 5 to 10 minutes. The blended sample was also pressed by a force of 0 to 50 kgf/cm² for about 1 to 5 minutes, and the vacuum was then broken. The iron plates were removed, and the sample was then cooled to shape. The sample was then taken from the mold frame to obtain PET/PEF blend sheet. The sheet was then pre-heated to 105° C. by the biaxial stretcher (KARO IV), and then simultaneously biaxially stretched along MD and TD at a stretching rate of 30%/second, in which both the stretching ratios of MD and TD were 3.0 times. The thickness and OTR of the stretched sheet are shown in Table 2.

### Example 1-2

90 parts by weight of PET 5015w and 10 parts by weight of the modified PEF in Preparation Example 2 were put into a micro-compounder (Xplore 15 ml, DSM) in a batch of about 10 g to 15 g under nitrogen, and then melt blended at 270° C. for 60 seconds at a screw rate of 100 rpm. The blended sample was directly extruded as a strip and then cut to pellets using a pelletizer. PET/PEF blend was hot pressed to shape with a vacuum laminator. PET/PEF blend was pre-treated at 140° C. under vacuum for 24 hours to determine that its water content ratio was less than 500 ppm. Next, the temperature of the vacuum laminator was set to be higher than the melting point of PET/PEF blend (e.g. 280° C.). A mold frame was put onto a Teflon glass fiber cloth, and the blended sample was placed into the mold frame. The blended sample was covered by another Teflon glass fiber cloth, and the above tri-layered structure was interposed between two iron plates, and then put into the vacuum laminator of the stabilized temperature (e.g. 280° C.). In the vacuum laminator, the pressure was reduced to less than 10 torr, and PET/PEF blend was melted for about 5 to 10 minutes. The blended sample was also pressed by a force of 0 to 50 kgf/cm² for about 1 to 5 minutes, and the vacuum was then broken. The iron plates were removed, and the sample was then cooled to shape. The sample was then taken from the mold frame to obtain PET/PEF blend sheet. The sheet was then pre-heated to 105° C. by the biaxial stretcher (KARO IV), and then simultaneously biaxially stretched along MD and TD at a stretching rate of 30%/second, in which both the stretching ratios of MD and TD were 4.0 times. The thickness and OTR of the stretched sheet are shown in Table 2.

TABLE 2

| | Example | Example | Comparative | Comparative | Comparative |
|---|---|---|---|---|---|
| | 1-1 | 1-2 | Example 1 | Example 2-1 | Example 2-2 |
| PET 5015w (wt %) | 90 | | 100 | 90 | |
| PEF (Preparation Example 1) | 0 | | 0 | 10 | |
| Modified PEF (Preparation | 10 | | 0 | 0 | |
| Example 2) | | | | | |
| Blending temperature | 270° C. | | None | 270° C. | |
| Blending period | 60 seconds | | None | 60 seconds | |
| Stretching ratio | 3 × 3 | 4 × 4 | None | 3 × 3 | 4 × 4 |
| Thickness (Micrometers) | 87 | 30 | 230 | 90 | 34 |
| Oxygen transmittance rate | 98.4 | 94.4 | 150 | 118 | 136 |
| (OTR)(cc · 25 μm/m² · day · atm, | | | | | |
| relative humidity was 0) | | | | | |
| OTR improvement % | 34.4 | 37.1 | — | 21.3 | 9.3 |

As shown in the comparison of Table 2, the blend of the modified PEF and PET had a lower OTR than that of the blend of PEF and PET.

### Example 2-1

90 parts by weight of PET 5015w and 10 parts by weight of the modified PEF in Preparation Example 3 were put into a micro-compounder (Xplore 15 ml, DSM) in a batch of about 10 g to 15 g under nitrogen, and then melt blended at 270° C. for 60 seconds at a screw rate of 100 rpm. The blended sample was directly extruded as a strip and then cut to pellets using a pelletizer. PET/PEF blend was hot pressed to shape with a vacuum laminator. PET/PEF blend was pre-treated at 140° C. under vacuum for 24 hours to determine that its water content ratio was less than 500 ppm. Next, the temperature of the vacuum laminator was set to be higher than the melting point of PET/PEF blend (e.g. 280° C.). A mold frame was put onto a Teflon glass fiber cloth, and the blended sample was placed into the mold frame. The blended sample was covered by another Teflon glass fiber cloth, and the above tri-layered structure was interposed between two iron plates, and then put into the vacuum laminator of the stabilized temperature (e.g. 280° C.). In the vacuum laminator, the pressure was reduced to less than 10 torr, and PET/PEF blend was melted for about 5 to 10 minutes. The blended sample was also pressed by a force of 0 to 50 kgf/cm² for about 1 to 5 minutes, and the vacuum was then broken. The iron plates were removed, and the sample was then cooled to shape. The sample was then taken from the mold frame to obtain PET/PEF blend sheet. The sheet was then pre-heated to 105° C. by the biaxial stretcher (KARO IV), and then simultaneously biaxially stretched along MD and TD at a stretching rate of 30%/second, in which both the stretching ratios of MD and TD were 3.0 times. The thickness and OTR of the stretched sheet are shown in Table 3.

### Example 2-2

90 parts by weight of PET 5015w and 10 parts by weight of the modified PEF in Preparation Example 3 were put into a micro-compounder (Xplore 15 ml, DSM) in a batch of about 10 g to 15 g under nitrogen, and then melt blended at 270° C. for 60 seconds at a screw rate of 100 rpm. The blended sample was directly extruded as a strip and then cut to pellets using a pelletizer. PET/PEF blend was hot pressed to shape with a vacuum laminator. PET/PEF blend was pre-treated at 140° C. under vacuum for 24 hours to determine that its water content ratio was less than 500 ppm. Next, the temperature of the vacuum laminator was set to be higher than the melting point of PET/PEF blend (e.g. 280° C.). A mold frame was put onto a Teflon glass fiber cloth, and the blended sample was placed into the mold frame. The blended sample was covered by another Teflon glass fiber cloth, and the above tri-layered structure was interposed between two iron plates, and then put into the vacuum laminator of the stabilized temperature (e.g. 280° C.). In the vacuum laminator, the pressure was reduced to less than 10 torr, and PET/PEF blend was melted for about 5 to 10 minutes. The blended sample was also pressed by a force of 0 to 50 kgf/cm² for about 1 to 5 minutes, and the vacuum was then broken. The iron plates were removed, and the sample was then cooled to shape. The sample was then taken from the mold frame to obtain PET/PEF blend sheet. The sheet was then pre-heated to 105° C. by the biaxial stretcher (KARO IV), and then simultaneously biaxially stretched along MD and TD at a stretching rate of 30%/second, in which both the stretching ratios of MD and TD were 4.0 times. The thickness and OTR of the stretched sheet are shown in Table 3.

TABLE 3

| | Example | Example | Comparative | Comparative | Comparative |
|---|---|---|---|---|---|
| | 2-1 | 2-2 | Example 1 | Example 2-1 | Example 2-2 |
| PET 5015w (wt %) | 90 | | 100 | 90 | |
| PEF (Preparation Example 1) | 0 | | 0 | 10 | |
| Modified PEF (Preparation | 10 | | 0 | 0 | |
| Example 3) | | | | | |
| Blending temperature | 270° C. | | None | 270° C. | |
| Blending period | 60 seconds | | None | 60 seconds | |
| Stretching ratio | 3 × 3 | 4 × 4 | None | 3 × 3 | 4 × 4 |
| Thickness (Micrometers) | 56 | 28 | 230 | 90 | 34 |
| Oxygen transmittance rate | 113 | 85 | 150 | 118 | 136 |
| (OTR)(cc · 25 μm/m² · day · atm, | | | | | |
| relative humidity was 0) | | | | | |
| OTR improvement % | 25 | 43 | — | 21.3 | 9.3 |

As shown in the comparison of Table 3, the blend of the modified PEF and PET had a lower OTR than that of the blend of PEF and PET.

### Example 3

90 parts by weight of PET 5015w and 10 parts by weight of the modified PEF in Preparation Example 4 were put into a micro-compounder (Xplore 15 ml, DSM) in a batch of about 10 g to 15 g under nitrogen, and then melt blended at 270° C. for 60 seconds at a screw rate of 100 rpm. The blended sample was directly extruded as a strip and then cut to pellets using a pelletizer. PET/PEF blend was hot pressed to shape with a vacuum laminator. PET/PEF blend was pre-treated at 140° C. under vacuum for 24 hours to determine that its water content ratio was less than 500 ppm. Next, the temperature of the vacuum laminator was set to be higher than the melting point of PET/PEF blend (e.g. 280° C.). A mold frame was put onto a Teflon glass fiber cloth, and the blended sample was placed into the mold frame. The blended sample was covered by another Teflon glass fiber cloth, and the above tri-layered structure was interposed between two iron plates, and then put into the vacuum laminator of the stabilized temperature (e.g. 280° C.). In the vacuum laminator, the pressure was reduced to less than 10 torr, and PET/PEF blend was melted for about 5 to 10 minutes. The blended sample was also pressed by a force of 0 to 50 kgf/cm² for about 1 to 5 minutes, and the vacuum was then broken. The iron plates were removed, and the sample was then cooled to shape. The sample was then taken from the mold frame to obtain PET/PEF blend sheet. The sheet was then pre-heated to 105° C. by the biaxial stretcher (KARO IV), and then simultaneously biaxially stretched along MD and TD at a stretching rate of 30%/second, in which both the stretching ratios of MD and TD were 4.0 times. The thickness and OTR of the stretched sheet are shown in Table 4.

### Example 4-1

90 parts by weight of PET 5015w and 10 parts by weight of the modified PEF in Preparation Example 4 were put into a micro-compounder (Xplore 15 ml, DSM) in a batch of about 10 g to 15 g under nitrogen, and then melt blended at 270° C. for 300 seconds at a screw rate of 100 rpm. The blended sample was directly extruded as a strip and then cut to pellets using a pelletizer. PET/PEF blend was hot pressed to shape with a vacuum laminator. PET/PEF blend was pre-treated at 140° C. under vacuum for 24 hours to determine that its water content ratio was less than 500 ppm. Next, the temperature of the vacuum laminator was set to be higher than the melting point of PET/PEF blend (e.g. 280° C.). A mold frame was put onto a Teflon glass fiber cloth, and the blended sample was placed into the mold frame. The blended sample was covered by another Teflon glass fiber cloth, and the above tri-layered structure was interposed between two iron plates, and then put into the vacuum laminator of the stabilized temperature (e.g. 280° C.). In the vacuum laminator, the pressure was reduced to less than 10 torr, and PET/PEF blend was melted for about 5 to 10 minutes. The blended sample was also pressed by a force of 0 to 50 kgf/cm² for about 1 to 5 minutes, and the vacuum was then broken. The iron plates were removed, and the sample was then cooled to shape. The sample was then taken from the mold frame to obtain PET/PEF blend sheet. The sheet was then pre-heated to 105° C. by the biaxial stretcher (KARO IV), and then simultaneously biaxially stretched along MD and TD at a stretching rate of 30%/second, in which both the stretching ratios of MD and TD were 2.0 times. The thickness and OTR of the stretched sheet are shown in Table 4.

### Example 4-2

90 parts by weight of PET 5015w and 10 parts by weight of the modified PEF in Preparation Example 4 were put into a micro-compounder (Xplore 15 ml, DSM) in a batch of about 10 g to 15 g under nitrogen, and then melt blended at 270° C. for 300 seconds at a screw rate of 100 rpm. The blended sample was directly extruded as a strip and then cut to pellets using a pelletizer. PET/PEF blend was hot pressed to shape with a vacuum laminator. PET/PEF blend was pre-treated at 140° C. under vacuum for 24 hours to determine that its water content ratio was less than 500 ppm. Next, the temperature of the vacuum laminator was set to be higher than the melting point of PET/PEF blend (e.g. 280° C.). A mold frame was put onto a Teflon glass fiber cloth, and the blended sample was placed into the mold frame. The blended sample was covered by another Teflon glass fiber cloth, and the above tri-layered structure was interposed between two iron plates, and then put into the vacuum laminator of the stabilized temperature (e.g. 280° C.). In the vacuum laminator, the pressure was reduced to less than 10 torr, and PET/PEF blend was melted for about 5 to 10 minutes. The blended sample was also pressed by a force of 0 to 50 kgf/cm² for about 1 to 5 minutes, and the vacuum was then broken. The iron plates were removed, and the sample was then cooled to shape. The sample was then taken from the mold frame to obtain PET/PEF blend sheet. The sheet was then pre-heated to 105° C. by the biaxial stretcher (KARO IV), and then simultaneously biaxially stretched along MD and TD at a stretching rate of 30%/second, in which both the stretching ratios of MD and TD were 3.0 times. The thickness and OTR of the stretched sheet are shown in Table 4.

### Example 4-3

90 parts by weight of PET 5015w and 10 parts by weight of the modified PEF in Preparation Example 4 were put into a micro-compounder (Xplore 15 ml, DSM) in a batch of about 10 g to 15 g under nitrogen, and then melt blended at 270° C. for 300 seconds at a screw rate of 100 rpm. The blended sample was directly extruded as a strip and then cut to pellets using a pelletizer. PET/PEF blend was hot pressed to shape with a vacuum laminator. PET/PEF blend was pre-treated at 140° C. under vacuum for 24 hours to determine that its water content ratio was less than 500 ppm. Next, the temperature of the vacuum laminator was set to be higher than the melting point of PET/PEF blend (e.g. 280° C.). A mold frame was put onto a Teflon glass fiber cloth, and the blended sample was placed into the mold frame. The blended sample was covered by another Teflon glass fiber cloth, and the above tri-layered structure was interposed between two iron plates, and then put into the vacuum laminator of the stabilized temperature (e.g. 280° C.). In the vacuum laminator, the pressure was reduced to less than 10 torr, and PET/PEF blend was melted for about 5 to 10 minutes. The blended sample was also pressed by a force of 0 to 50 kgf/cm² for about 1 to 5 minutes, and the vacuum was then broken. The iron plates were removed, and the sample was then cooled to shape. The sample was then taken from the mold frame to obtain PET/PEF blend sheet. The sheet was then pre-heated to 105° C. by the biaxial stretcher (KARO IV), and then simultaneously biaxially stretched along MD and TD at a stretching rate of 30%/second, in which both the stretching ratios of MD and TD were 4.0 times. The thickness and OTR of the stretched sheet are shown in Table 4.

TABLE 4

| Example | Comparative | Example | Example | Example |
|---|---|---|---|---|
| 3 | Example 1 | 4-1 | 4-2 | 4-3 |

| PET 5015w (wt %) | 90 | | 100 | 90 |
|---|---|---|---|---|
| Modified PEF (Preparation | 10 | | 0 | 10 |
| Example 4) | | | | |
| Blending temperature | 270° | C. | None | 270° C. |
| Blending period | 60 | seconds | None | 300 seconds |

| | | | | | |
|---|---|---|---|---|---|
| Stretching ratio | 4 × 4 | None | 2 × 2 | 3 × 3 | 4 × 4 |
| Thickness (Micrometers) | 26 | 230 | 46 | 11 | 29 |
| Oxygen transmittance rate | 89 | 150 | 114 | 98 | 122 |
| (OTR)(cc · 25 μm/m² · day · atm, | | | | | |
| relative humidity was 0) | | | | | |
| OTR improvement % | 40.7 | — | 24 | 34.7 | 18.7 |

As shown in the comparison of Table 4, the blend of the modified PEF and PET had a lower OTR than that of PET.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A blend, comprising:
50 to 99 parts by weight of polyethylene terephthalate (PET); and
1 to 50 parts by weight of modified polyethylene furanoate (PEF), and PET and the modified PEF have a total weight of 100 parts by weight,
wherein the modified PEF is polymerized of diacid, ester of diacid, or a combination thereof and polyol;
the diacid, ester of diacid, or a combination thereof includes (1) furan dicarboxylic acid, dialkyl furandicarboxylate, or a combination thereof or (2) furan dicarboxylic acid, dialkyl furandicarboxylate, or a combination thereof and spiro-diacid; and the polyol includes (3) C₂-C₁₄ polyol or (4) C₂-C₁₄ polyol and spiro-diol;
wherein the spiro-diol has a Formula (I): 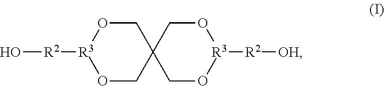
and the spiro-diacid has a Formula (II): 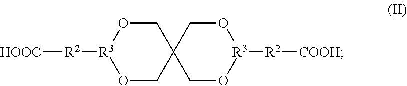
wherein each R² is independently single bond, 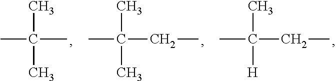
or C₁-C₄ linear alkylene; and
each R³ is independently 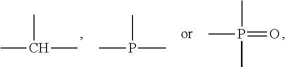
and
when (a) diacid, ester of diacid, or a combination thereof includes 1 part by mole of (1) furan dicarboxylic acid, dialkyl furandicarboxylate, or a combination thereof, the polyol includes 1 to 3 parts by mole of (4) C₂-C₁₄ polyol and spiro-diol, and the spiro-diol and the furan dicarboxylic acid, dialkyl furandicarboxylate, or a combination thereof have a weight ratio of 500 ppm to 4000 ppm; or
when (b) diacid, ester of diacid, or a combination thereof includes 1 part by mole of (2) furan dicarboxylic acid, dialkyl furandicarboxylate, or a combination thereof and spiro-diacid, the polyol includes 1 to 3 parts by mole of (3) C₂-C₁₄ polyol or (4) C₂-C₁₄ polyol and spiro-diol, wherein the spiro-diacid and the furan dicarboxylic acid, dialkyl furandicarboxylate, or a combination thereof have a weight ratio of 500 ppm to 4000 ppm, or a total weight of the spiro-diacid and the spiro-diol and the weight of the furan dicarboxylic acid, dialkyl furandicarboxylate, or a combination thereof have a ratio of 500 ppm to 4000 ppm.

2. The blend as claimed in claim 1, wherein the modified PEF has a number average molecular weight of 30,000 to 100,000.

3. The blend as claimed in claim 1, wherein PET has a number average weight molecular weight of 10,000 to 100,000.

4. The blend as claimed in claim 1, wherein the furan dicarboxylic acid includes 2,5-furan dicarboxylic acid, 3,4-furan dicarboxylic acid, 2,3-furan dicarboxylic acid, or a combination thereof.

5. The blend as claimed in claim 1, wherein the dialkyl furandicarboxylate includes dimethyl furan-2,5-dicarboxylate, dimethyl furan-3,4-dicarboxylate, dimethyl furan-2,3-dicarboxylate, or a combination thereof.

6. The blend as claimed in claim 1, wherein the C₂-C₁₄ polyol includes ethylene glycol, 1,3-propylene glycol, glycerol, 1,4-butylene glycol, 1,5-pentylene glycol, neo-pentylene glycol, 1,6-hexylene glycol, 1,7-heptylene glycol, 1,8-octylene glycol, 1,9-nonylene glycol, decylene glycol, undecylene glycol, dodecylene glycol, tetradecylene glycol, rosin-diol, isosorbide, 2,5-furandiol, or a combination thereof.

7. A method of manufacturing a blend, comprising:
mixing diacid, ester of diacid, or a combination thereof with polyol to perform an esterification and a condensation polymerization for forming a prepolymer; and
performing a solid-state polymerization of the prepolymer to form a modified polyethylene furanoate (PEF); and
blending 50 to 99 parts by weight of polyethylene terephthalate (PET) and 1 to 50 parts by weight of the modified PEF to form a blend, and PET and the modified-PEF have a total weight of 100 parts by weight,
wherein the diacid, ester of diacid, or a combination thereof includes (1) furan dicarboxylic acid, dialkyl furandicarboxylate, or a combination thereof or (2) furan dicarboxylic acid, dialkyl furandicarboxylate, or a combination thereof and spiro-diacid; and the polyol includes (3) C₂-C₁₄ polyol or (4) C₂-C₁₄ polyol and spiro-diol;
wherein the spiro-diol has a Formula (I): 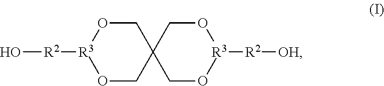
and the spiro-diacid has a Formula (II): 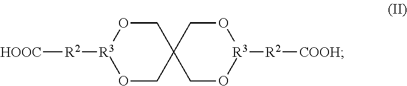
wherein each R² is independently single bond, 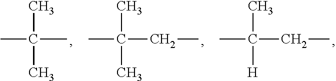
or C₁-C₄ linear alkylene; and
each R³ is independently 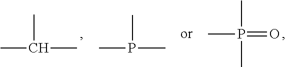
and
when (a) diacid, ester of diacid, or a combination thereof includes 1 part by mole of (1) furan dicarboxylic acid, dialkyl furandicarboxylate, or a combination thereof, the polyol includes 1 to 3 parts by mole of (4) C₂-C₁₄ polyol and spiro-diol, and the spiro-diol and the furan dicarboxylic acid, dialkyl furandicarboxylate, or a combination thereof have a weight ratio of 500 ppm to 4000 ppm; or
when (b) diacid, ester of diacid, or a combination thereof includes 1 part by mole of (2) furan dicarboxylic acid, dialkyl furandicarboxylate, or a combination thereof and spiro-diacid, the polyol includes 1 to 3 parts by mole of (3) C₂-C₁₄ polyol or (4) C₂-C₁₄ polyol and spiro-diol, wherein the spiro-diacid and the furan dicarboxylic acid, dialkyl furandicarboxylate, or a combination thereof have a weight ratio of 500 ppm to 4000 ppm, or a total weight of the spiro-diacid and the spiro-diol and the weight of the furan dicarboxylic acid, dialkyl furandicarboxylate, or a combination thereof have a ratio of 500 ppm to 4000 ppm.

8. The method as claimed in claim 7, wherein the step of blending PET and the modified PEF to form the blend is performed at a temperature of 265° C. to 300° C. for a period of 30 seconds to 500 seconds.

9. The method as claimed in claim 7, wherein the modified PEF has a number average molecular weight of 30,000 to 100,000.

10. The method as claimed in claim 1, wherein PET has a number average weight molecular weight of 10,000 to 100,000.
